(19) United States
(12) Patent Application Publication
(10) Pub. No.: US 2008/0281452 A1
(43) Pub. Date: Nov. 13, 2008

(54) Automatic Three-Dimensional Model Construction System

(75) Inventors: Shin Okamoto, Kanagawa (JP); Masaki Ikeda, Kanagawa (JP)

Correspondence Address: CROWELL & MORING LLP;INTELLECTUAL PROPERTY GROUP, P.O. BOX 14300, WASHINGTON, DC, 20044-4300, US

(73) Assignee: NSK Ltd., Shinagawa-ku (JP)

(21) Appl. No.: 11/547,138

(22) PCT Filed: Jun. 21, 2005
(86) PCT No.: PCT/JP2005/011363

§ 371 Date: Oct. 4, 2006

(30) Foreign Application Priority Data
Sep. 10, 2004 (JP) 2004-264639

(51) Int. Cl. G06F 19/00; G05B 19/18

(52) U.S. Cl. 700/98

(57) ABSTRACT

To efficiently construct a three-dimensional model. A product is divided into two parts of a head portion and a neck portion. A head form 34 and a neck form 36 are selected as forms of a three-dimensional model. The basic dimensions of each part are inputted to calculate dimension values of each part, and a combination of a basic form and a cut part is selected in accordance with a table 38. If it is necessary to change the basic form of the neck form 36, the dimensions of a basic-form model 40 are changed to construct a model 42. Furthermore, a cut part 48 is selected, and the model 42 is processed to construct a model 50. Then, by combining a head-form model 52 and the neck-form model 50, a three-dimensional model 54 of a bolt is constructed.

### TECHNICAL FIELD

The present invention relates an automatic three-dimensional model construction system, and in particular to an automatic three-dimensional model construction system preferable for construction of a three-dimensional model of a product with the use of a computer.

### BACKGROUND ART

As means for generating three-dimensional model data, there is conventionally known means, for example, what is provided with input means 1 for inputting data about a three-dimensional model, automatic design means 2 for automatically designing information necessary for a product form based on the data inputted by the input means 1, and product form construction means 3 for constructing a product form based on the information designed by the automatic design means 2, as shown in FIG. 6. When a three-dimensional model for various products is constructed based on a form defined on a two-dimensional plane, such a configuration that uses basic functions of a CAD system, such as rotation and extrusion, is adopted. In this case, when a model in a form similar to the form of the model defined on a two-dimensional plane is constructed, it can be automatically created by changing the dimensions of the basic-form model.

However, when a model in a form a part of which is different from the form of the model defined on a two-dimensional plane was constructed, manual modification work was required, and a lot of time was required for construction of the model. Furthermore, if a configuration is adopted in which a lot of dedicated models are created for each product and implemented in a system in order to cover various product forms, a lot of new form models must be constructed, and more time is required for construction of the models.

At the stage of designing, priority is given to construction of the form of a model. Therefore, when the form of a model did not meet processing conditions at a production site, it was actually forced to repeat review of specifications or trial production, and a lot of time was required for construction of the model.

The object of the present invention is to efficiently construct a three-dimensional model.

### DISCLOSURE OF THE INVENTION

In order to solve the problem, the present invention adopts an automatic three-dimensional model construction method for constructing a three-dimensional model with the use of a computer resource provided with a processing device resource, a memory resource, an input device and an interface, characterized in that the processing device resource executes, based on an operation program in the memory resource, processing configured by: a division step of dividing a product into multiple parts based on the form of the product; a parts configuration selection step of selecting, for the multiple parts, a combination of parts for which a model can be constructed with a basic form and parts for which a model can be constructed by processing the basic form; a part construction step of constructing basic-form models and constructing cut-part models by processing the basic-form model with the use of a cut part, for the parts selected at the parts configuration selection step; and a three-dimensional model construction step of constructing a three-dimensional model of the product by combining the basic-form models and the cut-part models constructed at the part construction step.

When the automatic three-dimensional model construction method is adopted, it is possible to construct the cut-part models in linkage with a tool library of a processing factory as the part construction step.

Furthermore, the present invention configures an automatic three-dimensional model construction system characterized in comprising: division means for dividing a product into multiple parts based on the form of the product; parts configuration selection means for selecting, for the multiple parts, a combination of parts for which a model can be constructed with a basic form and parts for which a model can be constructed by processing the basic form; part construction means for constructing basic-form models and constructing cut-part models by processing the basic-form model with the use of a cut part, for the parts selected by the parts configuration selection means; and three-dimensional model construction means for constructing a three-dimensional model of the product by combining the basic-form models and the cut-part models constructed by the part construction means.

Furthermore, the present invention configures an automatic three-dimensional model construction system characterized in comprising: form selection means for selecting a product form; input means for inputting basic dimension information about the product form; automatic design means for generating information necessary for construction of the product form based on the information inputted by the input means; parts configuration selection means for selecting, for multiple parts of the product form, a combination of parts for which a model can be constructed with a basic form and parts for which a model can be constructed by processing the basic form, based on the information generated by the automatic design means; part construction means for constructing basic-form models and constructing cut-part models by processing the basic-form model with the use of a cut part, for the parts selected by the parts configuration selection means; and three-dimensional model construction means for constructing a three-dimensional model of the product by combining the basic-form models and the cut-part models constructed by the part construction means.

According to such a configuration, a product is divided into multiple parts based on its form; a combination of parts for which a model can be constructed with a basic form and parts for which a model can be constructed by processing the basic form is selected for the multiple parts; for the selected parts, basic-form models are constructed and cut-part models are constructed by processing a basic-form model with the use of a cut part; and the basic-form models and the cut-part models are combined to construct a three-dimensional model of the product. Accordingly, by arbitrarily combining the basic-form models and the cut-part models, a three-dimensional model of the product can be efficiently constructed.

In configuring the automatic three-dimensional model construction system, a function of constructing the cut-part models in linkage with a tool library of a processing factory can be added to the part construction means. In this case, by constructing the cut-part models in linkage with the tool library of the processing factory, it is possible to cooperate with a production site and perform processing simulation at the stage of designing. As a result, by performing design review and trial production between a designer and the processing factory, it is possible to reduce not only the time required for determination of the use but also the number of trial productions.

Furthermore, the present invention relates to a program for causing a computer to execute processing realized as each means and a storage medium in which this program is stored. As an example of the storage medium, memory means such as a CD-ROM and a DVD-ROM can be given.

### BRIEF DESCRIPTION OF THE DRAWINGS

FIG. 1 is a block configuration diagram of an automatic three-dimensional model construction system showing an embodiment of the present invention;

FIG. 2 is a basic configuration diagram of the automatic three-dimensional model construction system according to the present invention;

FIG. 3 is a flowchart for illustrating the operation of the automatic three-dimensional model construction system shown in FIG. 1;

FIGS. 4A to 4G are diagrams for illustrating the content of processing for construction of a three-dimensional model;

FIG. 5 is a diagram for illustrating relation between cut part and the three-dimensional model; and

FIG. 6 is a configuration diagram of a conventional automatic three-dimensional model construction system.

### DESCRIPTION OF SYMBOLS

10 computer
12 keyboard
14 mouse
16 hard disk
18 display device

### BEST MODE FOR CARRYING OUT THE INVENTION

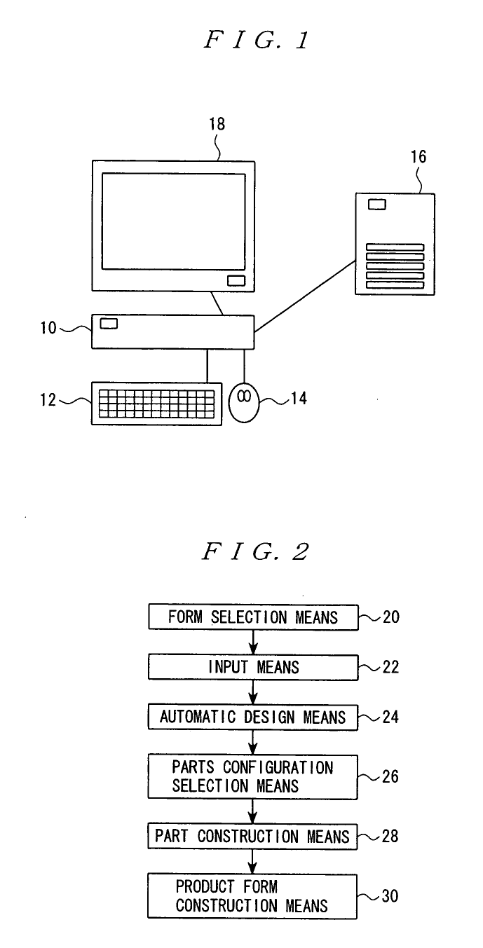

An embodiment of the present invention will be described below based on drawings. FIG. 1 is a block configuration diagram of an automatic three-dimensional model construction system showing an embodiment of the present invention.

In FIG. 1, the automatic three-dimensional model construction system is configured to be provided with a computer 10, a keyboard 12, a mouse 14, a hard disk 16 and a display device 18.

The computer 10, as a processing device resource, acquires product form information about various products from the hard disk (memory resource) 16 in accordance with a program for constructing a three-dimensional model and displays an image based on the acquired product form information on the screen of the display device 18. In this case, the keyboard 12 and the mouse 14, as input devices, function as form selection means 20 and input means 22 as shown in FIG. 2 to select a product form in accordance with an operator's operation and input information about the selected product form, such as basic dimensions. When the information such as basic dimensions is inputted by the input means 22 for the product form selected by the form selection means 20, the computer 10, as automatic design means 24, creates information necessary for construction of the product form based on the inputted information in accordance with a predetermined procedure. That is, the automatic design means 24 functions as division means for dividing a product into multiple parts based on its form, and it is also provided with a function as classification means for classifying the respective parts as parts which can be constructed with a basic-form model and as parts which can be constructed by processing a basic-form model.

The computer 10 further functions as parts configuration selection means 26 for selecting, for the parts classified by the automatic design means 24, a combination of parts which can be constructed with a basic-form model and parts which can be constructed by processing a basic-form model, as parts necessary for construction of the product form.

The computer 10 further functions as part construction means 28 for constructing basic-form models based on the information obtained by the automatic design means 24, and constructing cut-part models by transforming a basic-form model and then using a cut part, for the parts selected by the parts configuration selection means 26.

The computer 10, as product form construction means 30, further functions as three-dimensional model construction means for constructing a three-dimensional model of the product by combining the basic-form models and the cut-part models.

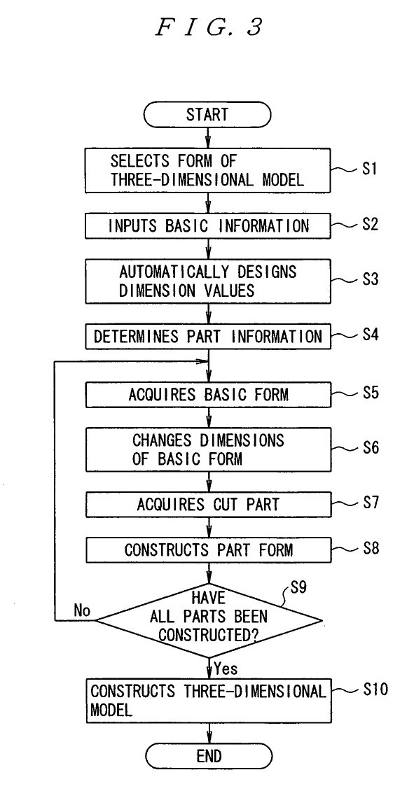

A specific example will be described below based on the flowchart in FIG. 3.

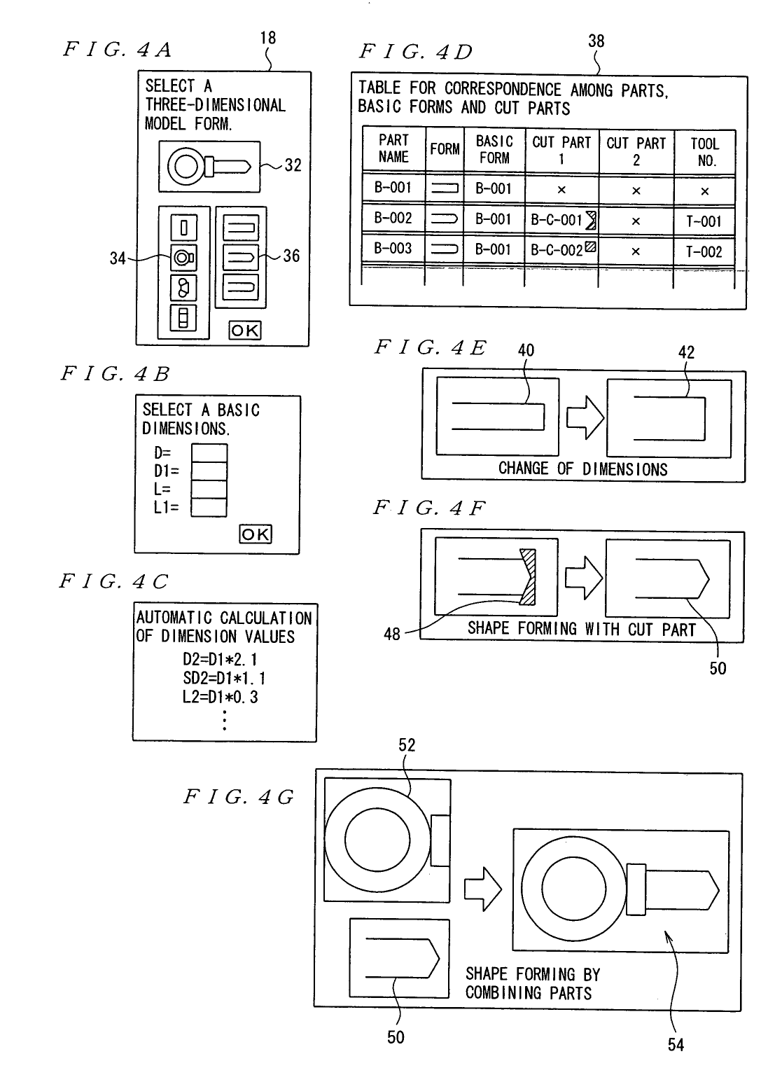

First, when a finished form 32, a head form 34 and a neck form 36, for example, are displayed as forms of a three-dimensional model of a product on the screen of the display device 18 as shown in FIG. 4A, any of the forms is selected by operating the keyboard 12 and the mouse 14 (step S1). Next, for the selected three-dimensional model, information necessary for construction of a three-dimensional model, such as basic dimensions, is inputted as initial values as shown in FIG. 4B (step S2). Next, as shown in FIG. 4C, the dimension values necessary for construction of the three-dimensional model are calculated in accordance with an automatic dimension value design program set in advance (step S3).

Next, as shown in FIG. 4D, a combination of a basic form and a cut part is selected from a table 38 stored in the hard disk 16, and part information is determined (step S4). In the table 38, there is stored information about each of multiple parts obtained by dividing a product and classified as a part which can be constructed with a basic-form model or a part which can be constructed by processing a basic-form model.

Next, a basic form is acquired from a basic form library in the hard disk 16 (step S5). Then, as shown in FIG. 4E, the dimensions of the basic form are changed based on the dimension values calculated at step S3, and a shape is formed (step S6).

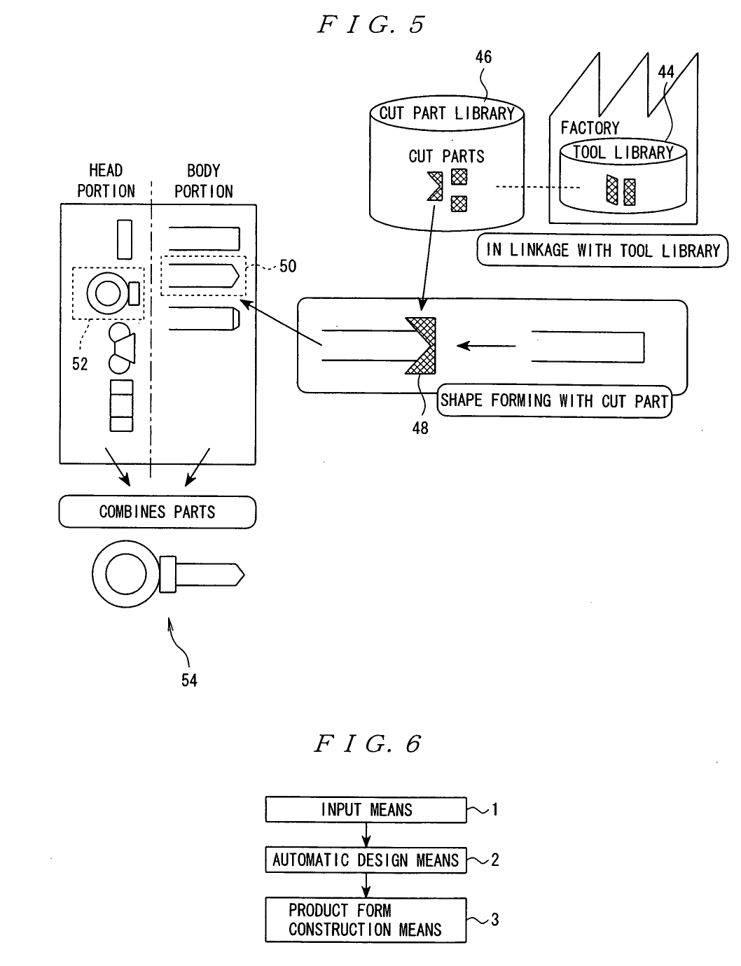

Next, as shown in FIG. 5, a cut part 48 is acquired from a cut part library 46 linked to a tool library 44 of a processing factory (step S7). Next, as shown in FIG. 4F, shape forming is performed to cut the end part of a model 42 with the changed dimensions, with the use of the cut part 48, and a cut part model 50 formed with the use of the cut part 48 is constructed (step S8).

Next, it is determined whether or not a model has been constructed for all the parts (step S9). If it is determined that a model has not been constructed for all the parts, then the processings at steps S5 to S8 are executed. If it is determined that a model has been constructed for all the parts, as shown in FIG. 4G, then all the constructed parts, for example, a head model 52 and a body model 50 are combined to construct a three-dimensional model 54 (step S10).

That is, as shown in FIG. 5, when the product is a bolt which is configured by a head portion and a neck portion, the bolt is divided into two parts of the head portion and the neck portion, and a neck portion model 50 is configured by a model 42 obtained by changing the dimensions of a basic form 40 and a model 50 obtained by using a cut part 48. Then, by combining a head portion model 52 and the neck portion model 50 to construct a three-dimensional model 54 for the bolt. In this case, since the cut part 48 is linked to the tool library 44 of the processing factory, CAM simulation can be performed at the initial stage of designing, and it is possible not only to reduce the number of trial productions but also to perform more efficient design.

According to this embodiment, the form of a product is divided into multiple parts, the models of the respective parts are classified as basic-form models and cut-part models using a cut part, and a three-dimensional model is constructed by combining the basic-form models and the cut-part models. Thereby, it is possible to efficiently construct a three-dimensional model and shorten the time required for construction of the three-dimensional model.

Furthermore, according to this embodiment, by arbitrarily combining basic-form models and cut-part models using a cut part, it is possible to cover more product forms and reduce the maintenance load of the system.

### INDUSTRIAL APPLICABILITY

According to the present invention, it is possible to efficiently construct a three-dimensional model of a product.

1. An automatic three-dimensional model construction method for constructing a three-dimensional model with the use of a computer resource provided with a processing device resource, a memory resource, an input device and an interface, wherein
the processing device resource executes, based on an operation program in the memory resource, processing configured by: a division step of dividing a product into multiple parts based on the form of the product; a parts configuration selection step of selecting, for the multiple parts, a combination of parts for which a model can be constructed with a basic form and parts for which a model can be constructed by processing the basic form; a part construction step of constructing basic-form models and constructing cut-part models by processing the basic-form model with the use of a cut part, for the parts selected at the parts configuration selection step; and a three-dimensional model construction step of constructing a three-dimensional model of the product by combining the basic-form models and the cut-part models constructed at the part construction step.

2. The automatic three-dimensional model construction method according to claim 1, wherein
the part construction step constructs the cut-part models in linkage with a tool library of a processing factory.

3. An automatic three-dimensional model construction system comprising: division means for dividing a product into multiple parts based on the form of the product; parts configuration selection means for selecting, for the multiple parts, a combination of parts for which a model can be constructed with a basic form and parts for which a model can be constructed by processing the basic form; part construction means for constructing basic-form models and constructing cut-part models by processing the basic-form model with the use of a cut part, for the parts selected by the parts configuration selection means; and three-dimensional model construction means for constructing a three-dimensional model of the product by combining the basic-form models and the cut-part models constructed by the part construction means.

4. An automatic three-dimensional model construction system comprising: form selection means for selecting a product form; input means for inputting basic dimension information about the product form; automatic design means for generating information necessary for construction of the product form based on the information inputted by the input means; parts configuration selection means for selecting, for multiple parts of the product form, a combination of parts for which a model can be constructed with a basic form and parts for which a model can be constructed by processing the basic form, based on the information generated by the automatic design means; part construction means for constructing basic-form models and constructing cut-part models by processing the basic-form model with the use of a cut part, for the parts selected by the parts configuration selection means; and three-dimensional model construction means for constructing a three-dimensional model of the product by combining the basic-form models and the cut-part models constructed by the part construction means.

5. The automatic three-dimensional model construction system according to claim 3, wherein
the part construction means constructs the cut-part models in linkage with a tool library of a processing factory.

6. An automatic three-dimensional model construction program comprising a program for causing a computer to execute processing realized as each means according to claim 3.

7. A storage medium characterized in being a computer-readable storage medium in which the automatic three-dimensional model construction program according to claim 6 is stored.

8. The automatic three-dimensional model construction system according to claim 4, wherein
the part construction means constructs the cut-part models in linkage with a tool library of a processing factory.

9. An automatic three-dimensional model construction program comprising a program for causing a computer to execute processing realized as each means according to claim 4.

10. An automatic three-dimensional model construction program comprising a program for causing a computer to execute processing realized as each means according to claim 5.

11. An automatic three-dimensional model construction program comprising a program for causing a computer to execute processing realized as each means according to claim 8.

12. A storage medium characterized in being a computer-readable storage medium in which the automatic three-dimensional model construction program according to claim 9 is stored.

13. A storage medium characterized in being a computer-readable storage medium in which the automatic three-dimensional model construction program according to claim 10 is stored.

14. A storage medium characterized in being a computer-readable storage medium in which the automatic three-dimensional model construction program according to claim 11 is stored.
